(19) United States
(12) Patent Application Publication
(10) Pub. No.: US 2026/0051598 A1
(43) Pub. Date: Feb. 19, 2026

(54) VEHICLE BATTERY ENCLOSURES INCLUDING PYROFUSE COMPARTMENTS

(71) Applicant: GM GLOBAL TECHNOLOGY OPERATIONS LLC, Detroit, MI (US)

(72) Inventors: Timothy Glenn ROSS, Washington, MI (US); William John BARTLOMIEJ, II, New Haven, MI (US); Amandeep Singh, Grosse Pointe Farms, MI (US); Trevor MILLER, Sterling Heights, MI (US); Mark Wade HERRELL, JR., Warren, MI (US); Hunter CLASEN, Interlochen, MI (US); William Thomas KUCINSKI, Windsor (CA)

(21) Appl. No.: 18/804,717

(22) Filed: Aug. 14, 2024

(51) Int. Cl. H01M 50/249; H01M 50/209; H01M 50/583

(52) U.S. Cl. CPC H01M 50/249; H01M 50/209; H01M 50/583; H01M 2220/20

(57) ABSTRACT

An example vehicle battery module includes a battery enclosure of a vehicle, the battery enclosure including multiple walls defining an interior of the battery enclosure, at least one battery located within the interior of the battery enclosure, the at least one battery configured to provide power for the vehicle, a pyrofuse electrically connected with the at least one battery, and a compartment located on at least one of the multiple walls of the battery enclosure, the compartment defining a space separate from the interior of the battery enclosure. The space defined by the compartment is accessible from an exterior of the battery enclosure without accessing the interior of the battery enclosure, and the pyrofuse is located within the space defined by the compartment.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to vehicle battery enclosures including pyrofuse compartments.

Electric vehicles include vehicle battery modules which provide power to electric components of the vehicle, such as an electric motor. The vehicle battery modules often operate at high voltages, and sometimes need to be serviced by a technician.

### SUMMARY

An example vehicle battery module includes a battery enclosure of a vehicle, the battery enclosure including multiple walls defining an interior of the battery enclosure, at least one battery located within the interior of the battery enclosure, the at least one battery configured to provide power for the vehicle, a pyrofuse electrically connected with the at least one battery, and a compartment located on at least one of the multiple walls of the battery enclosure, the compartment defining a space separate from the interior of the battery enclosure. The space defined by the compartment is accessible from an exterior of the battery enclosure without accessing the interior of the battery enclosure, and the pyrofuse is located within the space defined by the compartment.

In some examples, the pyrofuse is located adjacent to an outer wall of the battery enclosure to facilitate servicing of the pyrofuse independent of any other component of the battery module and without tearing down any other component of the battery module.

In some examples, the battery enclosure includes a battery disconnect unit (BDU) having a plastic housing, and the pyrofuse is located adjacent to an external wall of the battery disconnect unit.

In some examples, the pyrofuse is configured to sever a busbar connection with the at least one battery in response to a fuse trigger condition.

In some examples, the vehicle battery module includes an access panel removably coupled to the compartment. In some examples, a surface of the access panel is parallel to a plane of the at least one of the multiple walls.

In some examples, the compartment defines an opening along a surface of the at least one of the multiple walls, and the access panel is removably coupled at the opening of the compartment via a friction fit.

In some examples, the compartment includes five walls which separate the space defined by the compartment from the interior of the battery enclosure, and an open side exposed to an exterior of the battery enclosure.

In some examples, each wall of the compartment comprises an electrically insulative material. In some examples, the electrically insulative material is plastic.

In some examples, the pyrofuse includes at least one fingerproof female connector having an IPXXB rating, and at least one fingerproof male connector with an insulated bolt, having an IPXXB rating.

In some examples, the compartment is a first compartment and the pyrofuse is a first pyrofuse, and the vehicle battery module further includes a second compartment located on at least one of the multiple walls of the battery enclosure, the second compartment defining a space separate from the interior of the battery enclosure, wherein, the space defined by the second compartment is accessible from the exterior of the battery enclosure without accessing the interior of the battery enclosure, and a second pyrofuse is located within the space defined by the compartment.

In some examples, the first compartment and the second compartment are located on a same one of the multiple walls of the battery enclosure.

In some examples, the compartment is configured to facilitate replacement of the pyrofuse without accessing the interior of the battery enclosure. In some examples, the compartment is configured to facilitate replacement of the pyrofuse while the vehicle battery module is energized.

In some examples, the compartment is configured to facilitate replacement of the pyrofuse without disassembly of the vehicle battery module. In some examples, the compartment is rectangular.

An example vehicle battery module includes a battery enclosure of a vehicle, the battery enclosure including multiple walls defining an interior of the battery enclosure, at least one battery located within the interior of the battery enclosure, the at least one battery configured to provide power for the vehicle, a pyrofuse electrically connected with the at least one battery, a compartment located on at least one of the multiple walls of the battery enclosure, and an access panel removably coupled to the compartment, wherein the pyrofuse is located within the compartment.

In some examples, a surface of the access panel is parallel to a plane of the at least one of the multiple walls of the battery enclosure.

In some examples, the compartment defines an opening along a surface of the at least one of the multiple walls, and the access panel is removably coupled at the opening of the compartment via a friction fit.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example embodiment of a vehicle including a vehicle battery module including a pyrofuse component;

FIG. 2 is a side view of a vehicle battery enclosure including two pyrofuse compartments;

FIG. 3 is a side view of the vehicle battery enclosure of FIG. 2, including two access panels covering the pyrofuses;

FIG. 4 is an orthogonal view of an example pyrofuse;

FIG. 5 is an orthogonal view of an open compartment housing a pyrofuse;

FIG. 6 is an orthogonal view of the compartment of FIG. 5, after removal of the pyrofuse;

FIG. 7 is an example circuit diagram illustrating two pyrofuses connected with two vehicle batteries;

FIGS. 8 and 9 are orthogonal views of a battery disconnect unit aligned with external compartments for accessing pyrofuses; and

FIG. 10 is a front view of a battery disconnect unit prior to insertion within a battery module.

In the drawings, reference numbers may be reused to identify similar and/or identical elements.

### DETAILED DESCRIPTION

Some example embodiments herein include example methods and systems for servicing a high voltage pyrofuse in a vehicle battery module, such as a high voltage Rechargeable Energy Storage System (RESS) of a vehicle. These example designs allow the pyrofuse to be easily accessed by service technicians, while retaining protection for the technicians (e.g., an IPXXB fingerproof environment) throughout the service procedure. The designs may also facilitate servicing of the pyrofuse without disassembly or partial disassembly of the vehicle battery module.

Example serviceable pyrofuse designs may combine fingerproof terminals on the pyrofuse (e.g., to an IPXXB rating), a dedicated pyrofuse mount on a vehicle battery module (e.g., a battery disconnect unit (BDU)), and removable access panels on the RESS tray structure. In some production systems that use a high voltage pyrofuse, the pyrofuse does not have fingerproof protection. Pyrofuses may be packaged internally to the BDU, where the shell/housing of the BDU provides high voltage protection for assembly plant operators. However, in this configuration, the pyrofuse is not easily serviced, and may require de-energization and disassembly of the RESS before service can begin.

Example fingerproof pyrofuses may include a combination of IPXXB fingerproof terminals, and insulated fasteners. This combination allows a service technician to service/remove the pyrofuse while voltage is still present in the vehicle battery module, without the need to de-energize the RESS. Similarly, because the pyrofuse may have dedicated fingerproofing, it can be packaged externally or semi-externally to the vehicle battery module, since the pyrofuse may not rely on the vehicle battery module housing for IPXXB fingerproofing.

External or semi-external mounting of the pyrofuse allows the pyrofuse to be placed in a convenient location for service. By using insulated bolts, a robust electrical connection between the pyro and RESS high voltage system may be established, which may provide enhanced protection and electrical connection compared to other methods such as push-fit connections which may be unacceptable for high-current applications.

In some examples, the pyrofuse is placed in a semi-external pocket (e.g., compartment) of the vehicle battery module. This compartment is separated from other high voltage components through geometry. For example, the compartment may include plastic walls for five sides of the pocket, and the RESS tray/access panel on the remaining side of the compartment. This pocket allows the pyrofuse to be serviced without an operator exposing themselves to unintended high voltage components during service (e.g., high voltage components in the interior of the vehicle battery module enclosure, which are separated from the pyrofuse by the walls of the pyrofuse compartment). The pocket, combined with IPXXB pyrofuse terminals, forms a “safety zone” that does not expose the technician to high voltage.

The pocket also allows easy assembly of the serviceable vehicle battery module at the RESS assembly plant.

As mentioned above, access panels may be mounted on a side (e.g., rear) of the vehicle battery module (such as an RESS tray). These serviceable access panels may be aligned with the pyrofuse pockets on the vehicle battery module. When the access panels are removed, the pyrofuse safety pocket is exposed, allowing a technician to easily remove the pyrofuse. Access panels may use a press-in-place (PIP) seal of sufficient geometry to ensure robust sealing to the RESS tray, and to ensure no additional leak electrical or other leak paths into the RESS.

Example designs described herein may provide an RESS system design that allows a high voltage pyrofuse to be easily serviced, such as an RESS system design that places the pyrofuse inside fingerproof connectors for safe service. For example, the system may be designed such that the pyrofuse can be serviced while energized, without excessive risk to service professionals.

In some examples, the RESS system design includes a fingerproof pyrofuse located inside a semi-external BDU pocket that is also fingerproof. The BDU semi-external pocket may be accessible to the service technician once an RESS outer access panel is removed. For example, the RESS access panel may be serviceable (e.g., removable, or able to be opened), where the fingerproof pyrofuse assembly is located behind the panel.

Example systems may be designed such that the BDU and RESS tray, in combination, allow for the pyrofuse to be serviced when the removable access panels are uninstalled. For example, the RESS system design may place the pyrofuse inside toolsafe connectors for safe service. The example system designs may allow the serviceable pyrofuse to be integrated into high voltage RESS without additional assembly steps required at an RESS assembly plant.

Example embodiments described herein may provide one or more advantages, such as an ability to easily service a pyrofuse in a vehicle battery module, an ability to seal the pyrofuse without significant disassembly of the vehicle battery module (e.g., an RESS), an ability to fingerproof the pyrofuse for service while maintaining a robust bolted connection, and ability to incorporate a serviceable pyrofuse in the RESS design without additional RESS assembly plant manufacturing steps required, and reduced service cost for servicing pyrofuse.

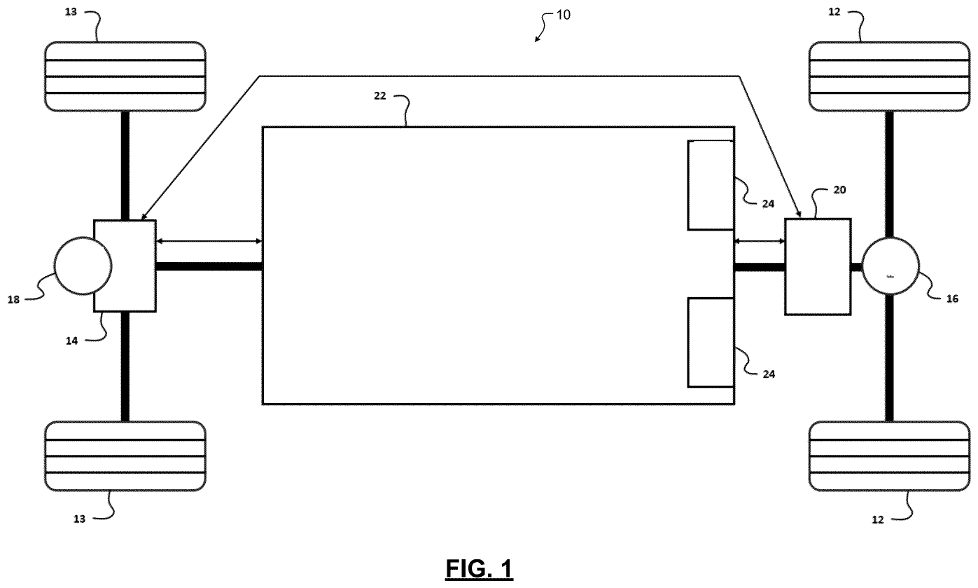

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control the operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, wheel position sensors, location sensors such as global positioning system (GPS) antennas, etc.). Some sensors may be configured to monitor current motion of the vehicle, acceleration of the vehicle, steering torque, etc.

As shown in FIG. 1, the vehicle 10 includes a vehicle battery module 22, which may include any suitable batteries for supplying power to the vehicle 10. For example, the vehicle battery module 22 may include one or more batteries, battery packs, etc., which can be recharged and store power to supply energy to the vehicle (such as lithium batteries). The batteries, battery packs, etc., may be connected with one another in any suitable arrangement, such as multiple groups in parallel, in series, etc. The vehicle battery module 22 may be considered as, or part of, a battery disconnect unit (BDU) or rechargeable energy storage system (RESS).

The vehicle battery module 22 may supply power to one or more components of the vehicle 10, such as the drive unit 14, the vehicle control module 20, other electronic components of the vehicle 10, etc. The vehicle control module 20 may be coupled to control charging and discharging of the vehicle battery module 22.

As shown in FIG. 1, the vehicle battery module 22 includes a pyrofuse compartment 24. The pyrofuse compartment 24 is configured to house a pyrofuse of the vehicle battery module 22. For example, the pyrofuse may be configured to quickly cut off a high voltage from the vehicle battery module 22 in response to a fuse trigger condition, such as a detected vehicle crash, an air bag deployment, an overcurrent condition, a thermal condition, etc. The pyrofuse may cut off the high voltage in any suitable manner, such as disconnecting an electrical connection, severing a busbar connection (e.g., via a knife), etc.

Although FIG. 1 illustrates one vehicle battery module 22 and one pyrofuse compartment 24, other example embodiments may have more vehicle battery modules, more pyrofuse compartments and corresponding pyrofuses, vehicle battery modules and pyrofuses at other locations in the vehicle, etc.

As described further below, the pyrofuse compartment 24 may be configured to allow access to the pyrofuse for servicing, while protecting a technician from high voltage components in an interior of an enclosure of the vehicle battery module 22. For example, the pyrofuse compartment 24 may include five plastic walls that separate a space of the pyrofuse compartment 24 from an interior of an enclosure of the vehicle battery module 22. The pyrofuse compartment 24 may be located on a side of the vehicle battery module 22, with one side of the pyrofuse compartment 24 open to the exterior of the vehicle battery module 22. The pyrofuse is located in the pyrofuse compartment 24, while the opening of the pyrofuse compartment is covered by an access panel to allow a technical to easily remove the access panel to service the pyrofuse.

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

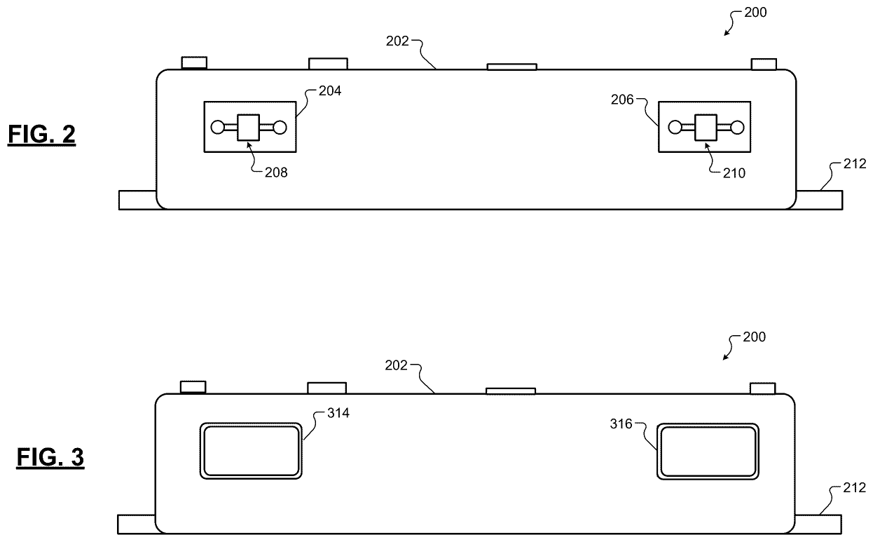

FIG. 2 is a side view of a vehicle battery module 200 including two pyrofuse compartments. The vehicle battery module 200 includes an enclosure 202, which may be a housing for multiple batteries, battery packs, etc. The enclosure 202 may be a housing for an RESS or BDU, and may include multiple side walls to protect the batteries inside the vehicle battery module 200. One or more rails 212 may be used to mount the vehicle battery module 200 inside a vehicle, to supply power to other components of the vehicle, to charge batteries inside the vehicle battery module 200, etc.

As shown in FIG. 2, a sidewall of the vehicle battery module 200 includes a first pyrofuse compartment 204 and a second pyrofuse compartment 206. A first pyrofuse 208 is located inside the first pyrofuse compartment 204, and a second pyrofuse 210 is located inside the second pyrofuse compartment 206.

As described further below, the first pyrofuse compartment 204 and the second pyrofuse compartment 206 may each define a space for their respective pyrofuses, which is separate from an interior of the enclosure 202. For example, the first pyrofuse compartment 204 and the second pyrofuse compartment 206 may each include five walls (e.g., plastic walls in a rectangular configuration), which separate the space of the pyrofuse compartment from the interior of the enclosure 202.

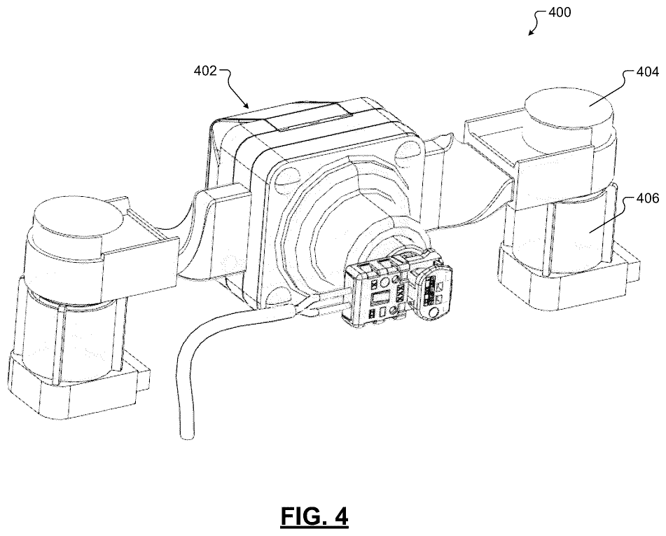

In this example, a sixth side of each of the first pyrofuse compartment 204 and the second pyrofuse compartment 206 may be open, to allow a technician to service the respective first pyrofuse 208 or second pyrofuse 210. For example, FIG. 2 may illustrate a position where access panels are removed to expose the insides of the first pyrofuse compartment 204 and the second pyrofuse compartment 206, where FIG. 3 illustrates a position where the access panels have been put back in place. Although FIG. 2 illustrates two pyrofuse compartments located on a same side of the enclosure 202, other example embodiments may include more or less pyrofuse compartments and pyrofuses, pyrofuse compartments and pyrofuses located on other portions of the enclosure 202, etc.

FIG. 3 is a side view of the vehicle battery module 200 of FIG. 2, including two access panels covering the pyrofuses. A first access panel 314 covers the first pyrofuse compartment 204, and a second access panel 316 covers the second pyrofuse compartment 206.

Each access panel may be coupled with the respective compartment in any suitable manner. For example, the first access panel 314 and the second access panel 316 may each include one or more seals, gaskets, etc., which protect the interiors of the first pyrofuse compartment 204 and the second pyrofuse compartment 206 when the first access panel 314 and the second access panel 316 are coupled with the enclosure 202 and/or the first pyrofuse compartment 204 and the second pyrofuse compartment 206.

In some examples, the first access panel 314 may be coupled with the first pyrofuse compartment 204 in a push-in-place (PIP) friction fit, and the second access panel 316 may be coupled with the second pyrofuse compartment 306 in a PIP friction fit. The access panels allow a technical to service and/or remove the pyrofuses while the vehicle battery module 200 is still energized, without requiring disassembly of the vehicle battery module 200, and while providing protection to the technician form high voltages in the interior of the enclosure 202. In other example embodiments, there may be more or less access panels, access panels having different shapes or sizes, access panels in different locations on the enclosure 202, etc.

FIG. 4 is an orthogonal view of an example pyrofuse 400. The pyrofuse 400 includes a pyrofuse component 402, which is configured to quickly cut off a high voltage of batteries inside the vehicle battery module. For example, the pyrofuse component 402 may quickly cut off a high voltage of the vehicle battery module in response to a fuse trigger condition, such as a detected vehicle crash, an air bag deployment, an overcurrent condition, a thermal condition, etc. The pyrofuse may cut off the high voltage in any suitable manner, such as disconnecting an electrical connection, severing a busbar connection (e.g., via a knife), etc.

Pyrofuses are common in battery packs for electric vehicles. The pyrofuses may be configured for one time use, where they are no longer useable after a fuse trigger event. Pyrofuses raise the possibility of nuisance activation. Example embodiments described herein may provide a solution for replacing the pyrofuse, which does not require disassembly of entire battery pack.

In some cases, all relays, contactors, fuses, etc. are in a common box buried in the BDU. Example embodiments described herein include a pyrofuse which is located in a pocket or semi-pocket of the BDU. The pyrofuse compartment may facilitate providing fingerproof protection against high voltage contact while servicing the pyrofuse, and limit access to other parts of the BDU. The pyrofuse compartment can make it safe for the technician to touch parts of the compartment and the pyrofuse while servicing the pyrofuse. For example, terminals of the pyrofuse may also be fingerproof to allow contact with a bolt, where a plastic cap is used.

Example pyrofuses may completely sever a busbar connection (e.g., via a knife, etc.), in response to a fuse trigger condition. The fuse trigger condition (e.g., event) may be triggered by a vehicle crash (e.g., an air bag deployment), an overcurrent condition, a thermal condition, etc., to quickly cutoff high voltage of the vehicle battery module.

In some examples, the pyrofuse compartment includes five sides of a box protruding into the interior of a BDU, along with an access panel. This allows the pyrofuse to stay within the footprint of an exterior of the vehicle battery module, while remaining accessible from an exterior of the vehicle battery module enclosure. In some examples, the pyrofuse is placed near the outer walls of the battery structure, and designed in such a way that no special tools are required for service. The pyrofuse can be serviced independent of any other battery pack component, with no need for teardown of other battery components (a benefit that is realized from the design of packaging near the outer walls and the fingerproofing).

For example, the pyrofuse may be housed in semi-external packaging on the BDU. While many pyrofuses are packaged deep within the BDU (i.e., not easily accessed), or independent of the BDU (i.e., requiring more part numbers and assembly steps), some example embodiments described herein house the pyrofuse in semi-external packaging on the BDU. Further, the plastic housing of the BDU provides for some of the fingerproofing while servicing the pyrofuse.

A circuit of the vehicle battery module, including the pyrofuse, may allow the pyrofuse to be serviceable while high voltage is applied in the vehicle battery module. In some examples, a plastic or nylon material (such as PA66 nylon), may be used for sides of the compartment and/or the access panel.

A press-in-place (PIP) gasket may be used to hold on the access panel. The access panel may prevent a bleed path into the battery pack, if a technician breaks it for example. Some example embodiments may allow a technician to service the pyrofuse without changing the circuitry,

As shown in FIG. 4, the pyrofuse 400 includes a fingerproof male connector 404 with insulated bolts. For example, the fingerproof male connector 404 may provide IPXXB rated protection to a technical servicing the pyrofuse 400. The pyrofuse 400 also includes a fingerproof female connector 406. The fingerproof female connector 406 may also provide IPXXB rated protection to a technical servicing the pyrofuse 400.

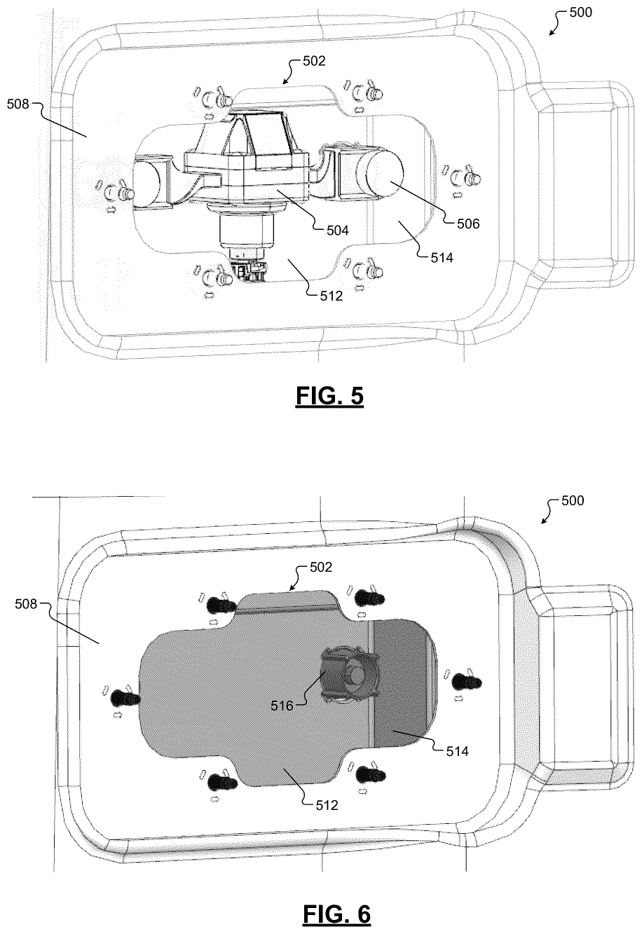

FIG. 5 is an orthogonal view of a vehicle battery module 500 including an open compartment 502 housing a pyrofuse 504. As shown in FIG. 5, the compartment 502 is mounted at an exterior wall 508 of an enclosure of the vehicle battery module 500. This allows a technician to access the compartment 502 from an exterior of the vehicle battery module 500, while being protected from high voltages in an interior of the enclosure of the vehicle battery module 500.

For example, the compartment 502 may include a back wall 512, and multiple side walls 514, which separate a space defined by the compartment 502 from the interior of the vehicle battery module 500. The walls of the compartment 502 may have any suitable material which is electrically insulative, such as plastic walls. In this manner, a technician may service the pyrofuse 504 while maintaining fingerproof protection from high voltages, including though use of a fingerproof connector 506 on the pyrofuse 504.

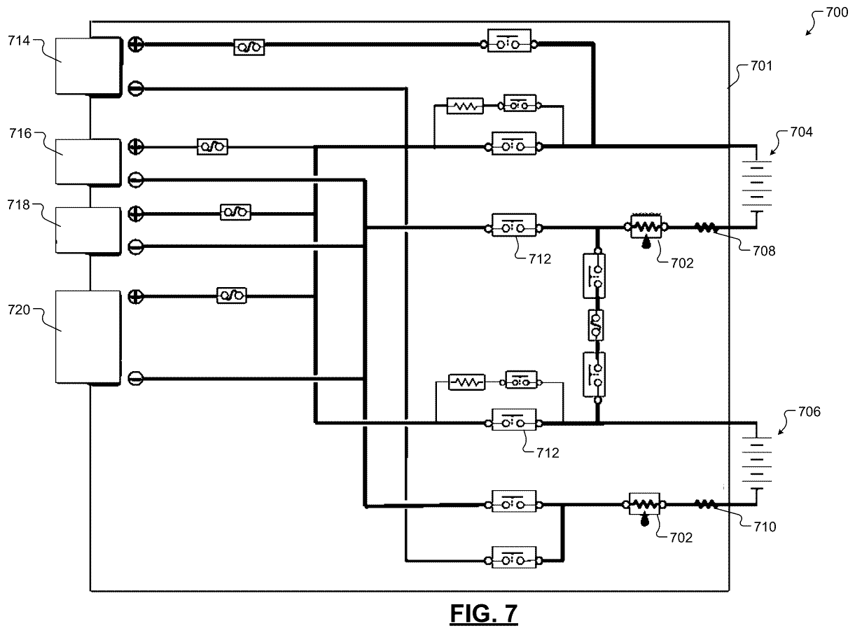

FIG. 6 is an orthogonal view of the compartment 502 of the vehicle battery module 500 of FIG. 5, after removal of the pyrofuse 504. As shown in FIG. 6, after removal of the pyrofuse 504, a space defined by the compartment 502 may be empty. A connector 516 may extend through a wall (e.g., the back wall 512) of the compartment 502, for connection of a new pyrofuse.

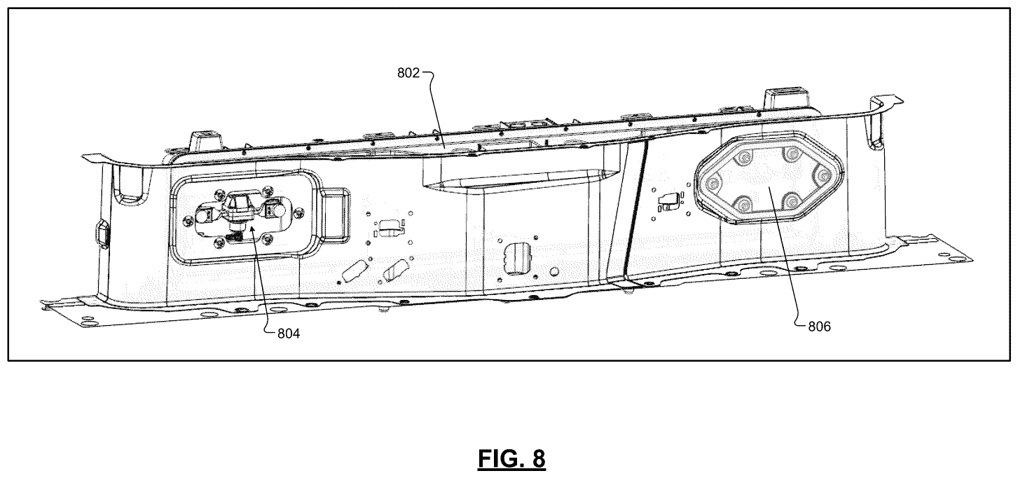

FIG. 7 is an example circuit diagram illustrating two pyrofuses connected with two vehicle batteries. As shown in FIG. 7, a circuit 700 includes a first battery 704 and a second battery 706. A first current sensor 708 is connected to sense a current flowing through the first battery 704, and a second current sensor 710 is connected to sense a current flowing through the second battery 706. As shown in the example of FIG. 7, the first battery 704 and the second battery 706 may be external to a battery disconnect unit 701, while other components are within the battery disconnect unit 701.

Pyrofuses 702 are connected with the first battery 704 and the 706, and may be configured to quickly cut off high voltage of the circuit 700 in response to a fuse trigger condition. The circuit 700 may include other circuit components for powering electrical components of the vehicle, such as switches 712, etc. The circuit 700 may provide power from the batteries to any suitable electrical systems or components of the vehicle (or vice versa), such as a direct current fast charging (DCFC) module 714, an integrated power electronics (IPE) module 716, a front drive power module 718, and a low power inverter module (LPIM) 720.

As shown in the example of FIG. 7, each pyrofuse 702 is permanently connected to the battery high voltage terminal, and cannot be switched “off”. The fingerproofing and BDU outer wall packaging of pyrofuse, as described in example embodiments herein, allows the pyrofuses 702 to be serviced while voltage is still present on the pyrofuses 702. If the fingerproofing and BDU outer wall packaging were not present, a service operator would have to significantly disassemble the battery pack, use a large amount of personal protective equipment (PPE), or the pyrofuse would have to be placed in a location where it can be switched off (which is not ideal for battery pack safety performance).

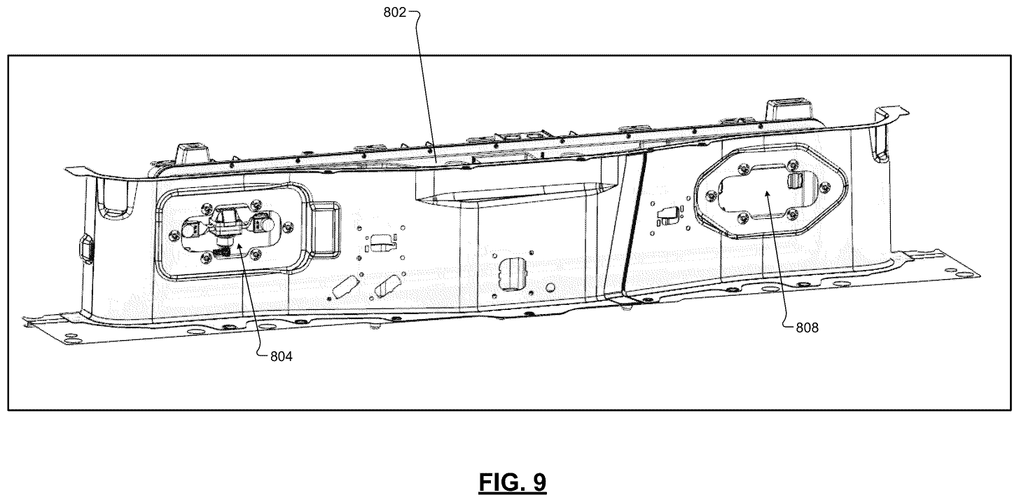

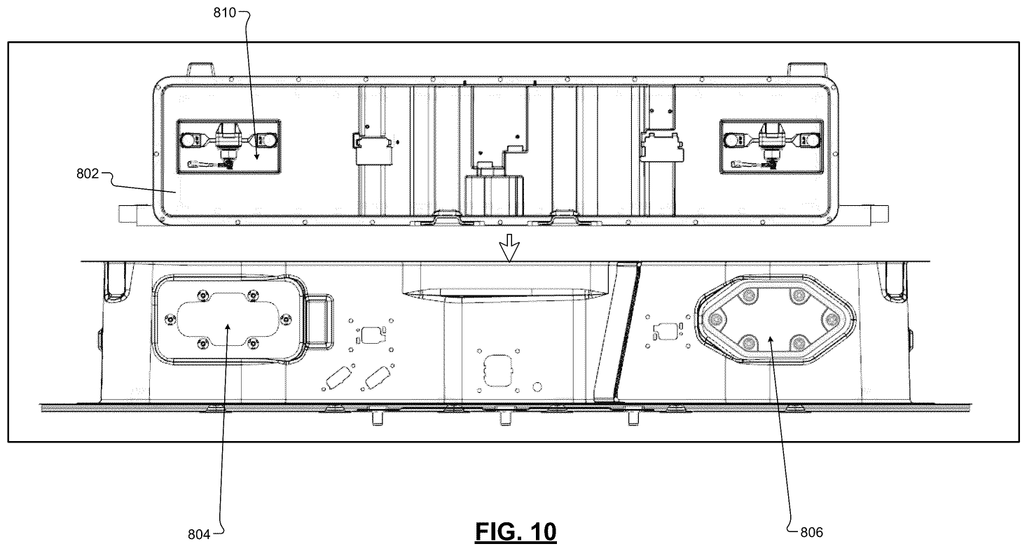

FIGS. 8 and 9 are orthogonal views of a battery disconnect unit 802 aligned with external compartments for accessing pyrofuses. As shown in FIG. 8, the driver's side access cover is removed to show partial disassembly state, where the compartment 804 is accessible to service the pyrofuse. The passenger's side access cover 806 is still attached. In FIG. 9, the passenger's side access cover is also removed so that the compartment 808 is accessible to service a pyrofuse.

FIG. 10 is a front view of a battery disconnect unit 802 prior to insertion within a battery module. The pack structure has the driver's side access panel removed. When loaded, the semi-external pyro pockets 810 on the BDU 802 will align with the access panels 804 and 806 of the tray.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle battery module comprising:
a battery enclosure of a vehicle, the battery enclosure including multiple walls defining an interior of the battery enclosure;
at least one battery located within the interior of the battery enclosure, the at least one battery configured to provide power for the vehicle;
a pyrofuse electrically connected with the at least one battery; and
a compartment located on at least one of the multiple walls of the battery enclosure, the compartment defining a space separate from the interior of the battery enclosure, wherein,
the space defined by the compartment is accessible from an exterior of the battery enclosure without accessing the interior of the battery enclosure, and
the pyrofuse is located within the space defined by the compartment.

2. The vehicle battery module of claim 1, wherein the pyrofuse is located adjacent to an outer wall of the battery enclosure to facilitate servicing of the pyrofuse independent of any other component of the battery module and without tearing down any other component of the battery module.

3. The vehicle battery module of claim 1, wherein:
the battery enclosure includes a battery disconnect unit (BDU) having a plastic housing; and
the pyrofuse is located adjacent to an external wall of the battery disconnect unit.

4. The vehicle battery module of claim 1, wherein the pyrofuse is configured to sever a busbar connection with the at least one battery in response to a fuse trigger condition.

5. The vehicle battery module of claim 1, further comprising an access panel removably coupled to the compartment.

6. The vehicle battery module of claim 5, wherein a surface of the access panel is parallel to a plane of the at least one of the multiple walls.

7. The vehicle battery module of claim 5, wherein:
the compartment defines an opening along a surface of the at least one of the multiple walls; and
the access panel is removably coupled at the opening of the compartment via a friction fit.

8. The vehicle battery module of claim 1, wherein the compartment includes five walls which separate the space defined by the compartment from the interior of the battery enclosure, and an open side exposed to an exterior of the battery enclosure.

9. The vehicle battery module of claim 8, wherein each wall of the compartment comprises an electrically insulative material.

10. The vehicle battery module of claim 9, wherein the electrically insulative material is plastic.

11. The vehicle battery module of claim 1, wherein the pyrofuse includes:
at least one fingerproof female connector having an IPXXB rating; and
at least one fingerproof male connector with an insulated bolt, having an IPXXB rating.

12. The vehicle battery module of claim 1, wherein the compartment is a first compartment and the pyrofuse is a first pyrofuse, and the vehicle battery module further includes:
a second compartment located on at least one of the multiple walls of the battery enclosure, the second compartment defining a space separate from the interior of the battery enclosure,
wherein, the space defined by the second compartment is accessible from the exterior of the battery enclosure without accessing the interior of the battery enclosure, and a second pyrofuse is located within the space defined by the compartment.

13. The vehicle battery module of claim 12, wherein the first compartment and the second compartment are located on a same one of the multiple walls of the battery enclosure.

14. The vehicle battery module of claim 1, wherein the compartment is configured to facilitate replacement of the pyrofuse without accessing the interior of the battery enclosure.

15. The vehicle battery module of claim 1, wherein the compartment is configured to facilitate replacement of the pyrofuse while the vehicle battery module is energized.

16. The vehicle battery module of claim 1, wherein the compartment is configured to facilitate replacement of the pyrofuse without disassembly of the vehicle battery module.

17. The vehicle battery module of claim 1, wherein the compartment is rectangular.

18. A vehicle battery module comprising:
a battery enclosure of a vehicle, the battery enclosure including multiple walls defining an interior of the battery enclosure;
at least one battery located within the interior of the battery enclosure, the at least one battery configured to provide power for the vehicle;
a pyrofuse electrically connected with the at least one battery;
a compartment located on at least one of the multiple walls of the battery enclosure; and
an access panel removably coupled to the compartment, wherein the pyrofuse is located within the compartment.

19. The vehicle battery module of claim 18, wherein a surface of the access panel is parallel to a plane of the at least one of the multiple walls of the battery enclosure.

20. The vehicle battery module of claim 18, wherein:
the compartment defines an opening along a surface of the at least one of the multiple walls; and
the access panel is removably coupled at the opening of the compartment via a friction fit.
